(19) United States
(12) Patent Application Publication
(10) Pub. No.: US 2008/0117343 A1
(43) Pub. Date: May 22, 2008

(54) Lightening ornament with a mirror

(76) Inventor: Chin-Lin Huang, Taipei County (TW)

Correspondence Address: BACON & THOMAS, PLLC, 625 SLATERS LANE, FOURTH FLOOR, ALEXANDRIA, VA, 22314, US

(21) Appl. No.: 11/600,854

(22) Filed: Nov. 17, 2006

(51) Int. Cl. F21L 4/00; A47B 19/00; G02F 1/13

(52) U.S. Cl. 349/1; 362/157; 362/183; 362/98

(57) ABSTRACT

A lightening ornament with a mirror, the ornament is used as a mirror when not in lightening, ornamental articles loaded in the ornament can be seen by irradiating of light rays through the mirror when in lightening of the lightening unit. The ornament at least comprises: a bottom plate with a receiving groove, an upper lid used to cover the bottom plate from above and is provided on its top with a mirror frame, a mirror provided in the mirror frame, at least a lightening unit, at least an electric power supply unit supplying electric power for the lightening unit, a switch and an ornamental article received in the receiving groove. When in lightening of the lightening unit, the mirror has a function of mirror image forming originally can give an effect of displaying the ornamental article loaded in the receiving groove; the ornament can be used as a key-ring ornamental pendant, an ornamental pendant for a mobile phone, a picture frame or a liquid crystal timer etc.

### BACKGROUND OF THE INVENTION

1. Field of the invention

The present invention relates to a lightening ornament with a mirror, and especially to an ornament with a mirror which can be used as a mirror when a lightening unit is not in lightening, ornamental articles loaded in the ornament can be seen through the mirror when in lightening of the lightening unit. The lightening ornament can be used as a key-ring ornamental pendant, a small ornamental pendant for a mobile phone, an ornament for a picture frame or a liquid crystal timer etc.

2. Description of the Prior Art

The structure of an ornament in designing mostly has a pattern or letters of an ornamental article provided in a small transparent plastic box directly, in order to directly see the pattern or letters of the ornamental article directly; alternatively, a key-ring ornament is directly provided thereon with a lightening unit, in order that the ornament can have a function of illumination when the lightening unit lightens.

Women tidy their appearances to keep brightness and beauty at any time, they always carry mirrors for making up; however, mirrors placed in handbags often are hard to find and are subjected to losing, using of them is inconvenient.

Thereby, if the function of a lightening key-ring ornament and a mirror can be combined so that the ornament not only can have the function of ornamenting and lightening, but also can make the mirror added thereon more convenient for carrying.

Further, if an ornament for office or house, such as a picture frame or a liquid crystal timer etc., can have both the functions of a mirror and its original owned, this commodity can have multiplied functions, thus their added values can be elevated.

Accordingly, the inventor of the present invention provides a lightening ornament with a mirror, the ornament is used as a mirror when not in lightening, ornamental articles loaded in the ornament can be seen by irradiating of light rays through the mirror when in lightening of the lightening unit; thus the ornament has the function of a mirror, and the ornamental articles loaded therein can be changed by oneself.

### SUMMARY OF THE INVENTION

The present invention provides a lightening ornament with a mirror, and especially an ornament with a mirror, ornamental articles loaded in the ornament can be seen through the mirror when in lightening of the lightening unit, the ornament is designed to be convenient for carrying, and thereby can be used as a key-ring ornamental pendant, a small ornamental pendant for a mobile phone, an ornament for a picture frame or a liquid crystal timer etc..

The lightening ornament with a mirror of the present invention at least comprises: a bottom plate, an upper lid, a mirror, at least a lightening unit, at least an electric power supply unit, a switch and an ornamental article. Wherein:

the bottom plate is provided thereon with a receiving groove and a lamp seat, it receives therein the electric power supply unit; the upper lid is used to cover the bottom plate from above, and is provided with a mirror frame in opposition to the receiving groove; the mirror is embedded in the mirror frame, a receiving space with a suitable interval is provided between the mirror and the bottom plate; the lightening unit is embedded in the lamp seat to project light to the receiving space; the electric power supply unit is provided on the bottom plate to supply electric power for the lightening unit for lightening; the switch is provided on the upper lid at a position in corresponding to that of the electric power supply unit to control electric connection or disconnection of the lightening unit with/from the electric power supply unit, so that supplying of electric power is under control; and the ornamental article is provided in the receiving space between the mirror and the receiving groove of the bottom plate.

The present invention further can be engaged with a key ring hanging an ornamental pendant, and the present invention can also be connected with a connecting member on a mobile phone to be used as a small ornamental pendant hanging on the mobile phone.

And more, in practice, the present invention can be used in cooperation with a picture frame or a liquid crystal timer in order that the latter has the function of a mirror, and has the function of displaying the ornamental articles in the receiving groove.

As compared to the prior art, the present invention includes the following gain in effect:

1. The ornament can have a plane used as a mirror, a pattern or letters or an ornamental article loaded in the ornament can be seen through the mirror when in lightening of the lightening unit; thus effects of low cost and convenient using can be obtained.

2. The designing of the lightening ornament can suit a key-ring ornamental pendant, a small ornamental pendant for a mobile phone, an ornament for a picture frame or a liquid crystal timer etc., its applicability is very broad.

The present invention will be apparent in its technical means after reading the detailed description of the preferred embodiment thereof in reference to the accompanying drawings.

### BRIEF DESCRIPTION OF THE DRAWINGS

FIG. 1 is an anatomic perspective view of the first embodiment of the present invention;

FIG. 2 is a perspective view of the first embodiment of the present invention after assembling;

FIG. 3 is a schematic perspective view of the first embodiment of the present invention when being used as a mirror;

FIG. 4 is a schematic perspective view of the first embodiment of the present invention showing operation of pressing a switch after insertion of an ornamental article;

FIG. 5 is a schematic perspective view of the first embodiment of the present invention showing operation before insertion of the ornamental article;

FIG. 6 is a schematic perspective view of the first embodiment of the present invention showing operation in insertion of the ornamental article;

FIG. 7 is a schematic perspective view of a second embodiment of the present invention showing its appearance when being used as a key-ring ornamental pendant;

FIG. 8 is a schematic perspective view of a third embodiment of the present invention showing its appearance when being used as an ornamental pendant for a mobile phone;

FIG. 9 is a schematic perspective view of a fourth embodiment of the present invention showing its appearance when being used as a picture frame when not in lightening;

FIG. 10 is a schematic perspective view of the fourth embodiment of the present invention showing its appearance when being used as a picture frame when in lightening;

FIG. 11 is a schematic perspective view of a fifth embodiment of the present invention showing its appearance when being used as a liquid crystal timer when not in lightening;

FIG. 12 is a schematic perspective view of the fifth embodiment of the present invention showing its appearance when being used as a liquid crystal timer when in lightening.

### DETAILED DESCRIPTION OF THE PREFERRED EMBODIMENT

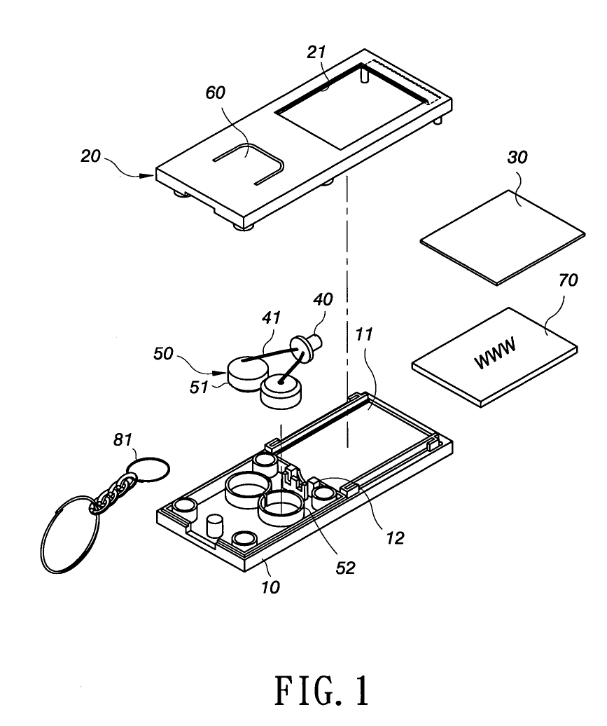

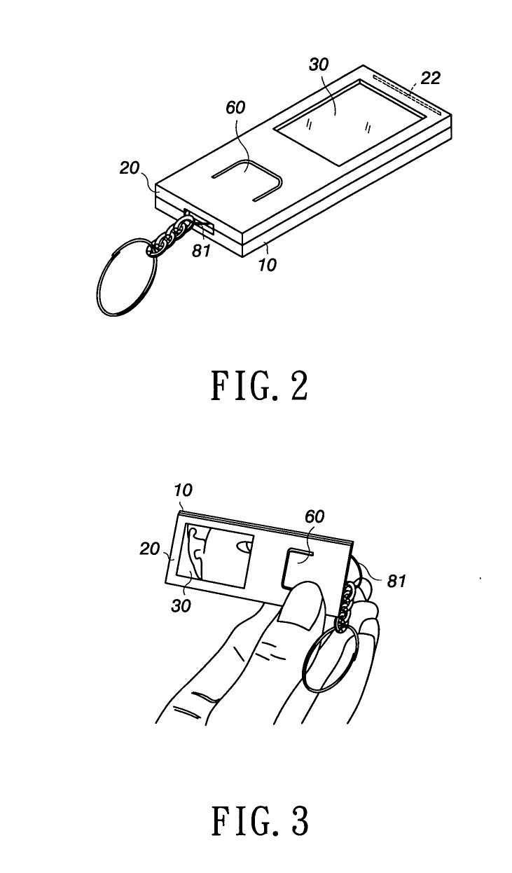

Referring to the FIGS. 1 and 2 firstly, the lightening ornament with a mirror of the present invention at least comprises: a bottom plate 10, an upper lid 20, a mirror 30, at least a lightening unit 40, at least an electric power supply unit 50, a switch 60 and an ornamental article 70. Wherein:

the bottom plate 10 is provided thereon with a receiving groove 11 and a lamp seat 12, it receives therein the electric power supply unit 50; the upper lid 20 is used to cover the bottom plate 10 from above, and is provided with a mirror frame 21 in opposition to the receiving groove 11; the upper lid 20 and the bottom plate 10 after being assembled can position all the members directly or indirectly.

The mirror 30 is embedded in the mirror frame 21, and is formed by electrically plating metallic element of chromium, nickel or aluminum onto one side or both sides of a transparent plate; the transparent plate can be made of polyvinyl chloride (PVC), polycarbonate (PC) or pure polymethacrylate—call as acryl (PPMA)—etc., thereby the mirror 30 can have two functions including light penetration and mirror image generating. The mirror 30 and the receiving groove 11 of the bottom plate 10 have therebetween a suitable interval to form a receiving space to receive therein an ornamental article 70.

The lightening unit 40 is embedded in the lamp seat 12 to project light to the receiving space; the lightening unit 40 is a light emitting diode (LED) having connecting pins 41.

The electric power supply unit 50 is provided on the bottom plate 10 to supply electric power for the lightening unit 40 for lightening. In practice, the electric power supply unit 50 is composed of two storage batteries 51 and two battery seats 52 provided on the bottom plate 10, the storage batteries 51 of the electric power supply unit 50 can be lithium batteries, normal batteries or rechargeable batteries, they can also be municipal electric power connected by an electric power line (not shown).

The switch 60 is provided on the upper lid 20 at a position in corresponding to that of the electric power supply unit 50 to control electric connection or disconnection of the lightening unit 40 with/from the electric power supply unit 50, so that supplying of electric power is under control. In practice, the switch 60 can be pressed to connect the connecting pins 41 of the lightening unit 40 with the electric power supply unit 50 to supply the electric power of the electric power supply unit 50 for the lightening unit 40 for lightening the latter.

The ornamental article 70 is provided in the receiving space between the mirror 30 and the receiving groove 11 of the bottom plate 10. The ornamental article 70 can be a sheet of paper, a plastic plate, a transparent member or a metallic plate having thereon a pattern, letters, a pattern with a plurality of letters, numerals, symbols etc., and can directly be a real ornamental thing (such as dry flower); in the present embodiment, a logo is printed on a sheet of paper to be the ornamental article 70; in order to avoid a paper sheet from too thin to prevent itself from sliding out of the receiving groove 11, a transparent glass, plastic or acryl plate can be placed on the paper to increase thickness.

As shown in FIG. 3, under the state that the switch 60 of the lightening ornament with the mirror 30 of the present invention is not pressed, the above stated receiving space between the mirror 30 and the receiving groove 11 of the bottom plate 10 becomes dark because the mirror 30 obscures light beams, when an outer light source irradiates on the outer surface of the mirror 30, by reflection of the mirror 30, a function of mirror image forming can be provided by the mirror 30.

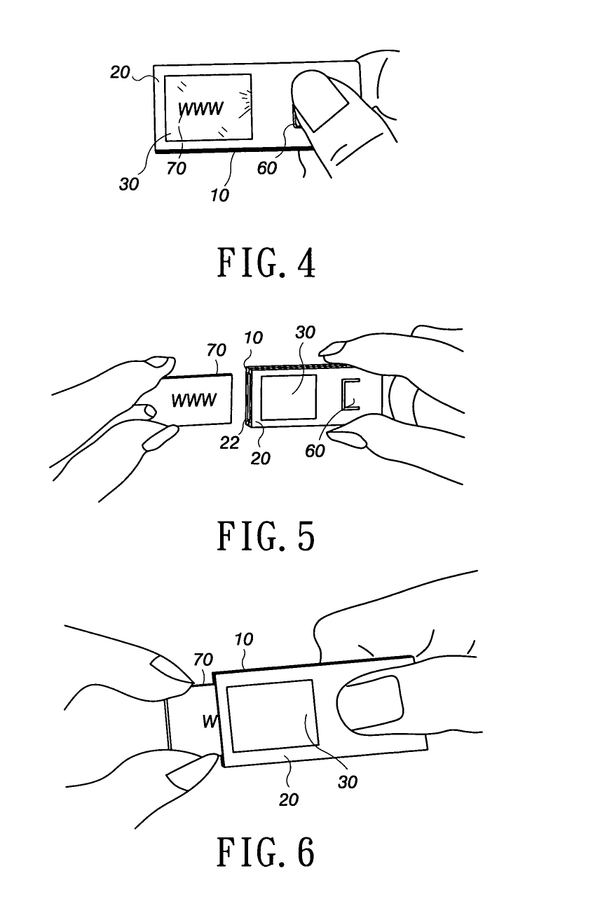

As shown in FIG. 4, in pressing the switch 60 of the lightening ornament with the mirror 30 of the present invention, the lightening unit 40 lightens to project light into the receiving space to make the inside of the receiving space which originally is dark by obscuring of the mirror 30 become bright, the mirror 30 having the effect of mirror image forming loses the dark background temporarily thus can allow a user to see the ornamental article 70 loaded in the receiving groove 11 through the mirror 30.

As shown in FIGS. 1, 2, 5 and 6, when in practice, the lightening ornament with the mirror 30 of the present invention can be provided on one edge of the receiving groove 11 with an opening 22 for placing or taking the ornamental article 70 in or out of the receiving groove 11.

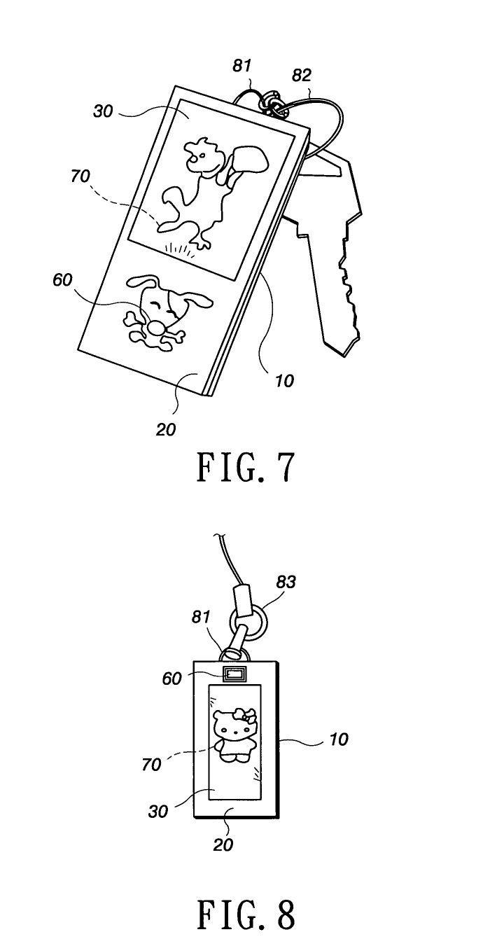

As shown in FIGS. 1, 2, 7 and 8, the lightening ornament with the mirror 30 of the present invention further is provided on the outer surface of the upper lid 20 or the bottom plate 10 with a connecting member 81 to be hung on a key ring 82 or a connecting line 83 on a mobile phone, thus a small ornamental pendant not subjected to losing is formed for carrying on one's person.

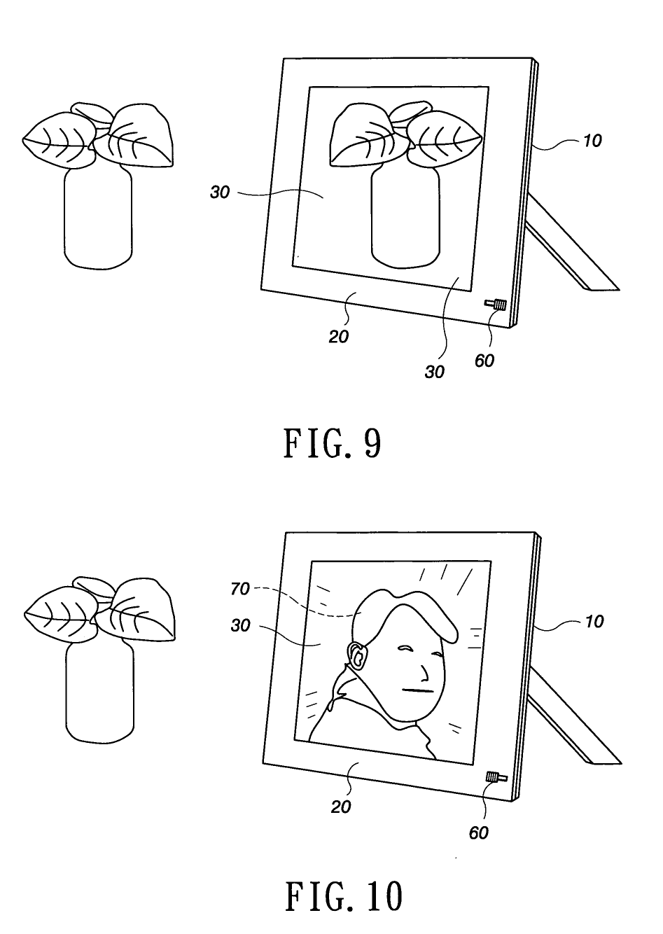

As shown in FIGS. 9 and 10 showing an embodiment of the lightening ornament with a mirror of the present invention used as a photo frame or picture frame, the photo frame or picture frame similarly has a bottom plate 10, an upper lid 20 and a mirror 30, and has on its outer surface a switch 60; its interior is same as the former embodiment, namely has at least a lightening unit 40, at least an electric power supply unit 50 and an ornamental article 70 which is similarly between the mirror 30 and the bottom plate 10; when the switch 60 is turned on to lighten the lightening unit 40, the ornamental article 70 such as a photo or picture loaded in the receiving groove 11 can appear. When a user turns off the switch 60 to thereby turn off the lightening unit 40, the mirror 30 gives an effect of mirror image forming to provide an added value, namely a function of displaying the photo or picture.

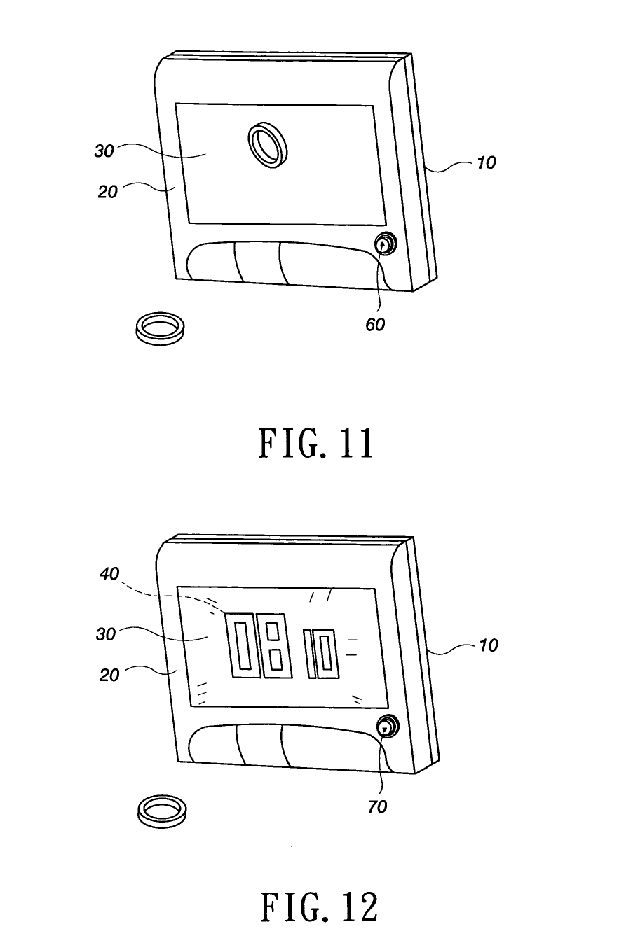

As shown in FIGS. 11 and 12 showing an embodiment of the lightening ornament with a mirror of the present invention used as a liquid crystal timer, the liquid crystal timer similarly has a bottom plate 10, an upper lid 20 and a mirror 30, and has on its outer surface a switch 60; its interior is same as the former embodiments, namely has at least a lightening unit 40, at least an electric power supply unit 50 and an ornamental article 70 which is similarly between the mirror 30 and the bottom plate 10; when the switch 60 is turned on to lighten the lightening unit 40, the ornamental article 70 (a liquid crystal display) loaded in the receiving groove 11 can appear. When a user turns off the switch 60 to thereby turn off the lightening unit 40, the mirror 30 gives an effect of mirror image forming to provide an added value, namely giving a function of the liquid crystal timer.

The names of the members and the drawings for the present invention are only for illustrating preferred embodiments of the present invention, and not for giving any limitation to the scope of the present invention. It will be apparent to those skilled in this art that various equivalent modifications or changes without departing from the spirit, scope and characteristic of this invention shall fall within the scope of the appended claims.

1. A lightening ornament with a mirror comprising:
a bottom plate, said bottom plate is provided thereon with a receiving groove and a lamp seat;
an upper lid, said upper lid is used to cover said bottom plate from above, and is provided with a mirror frame in opposition to said receiving groove;
a mirror, said mirror is embedded in said mirror frame, a receiving space with a set interval is provided between said mirror and said bottom plate;
at least a lightening unit, said lightening unit is embedded in a lamp seat to project light to said receiving space;
at least an electric power supply unit, said electric power supply unit is provided on said bottom plate to supply electric power for said lightening unit for lightening;
a switch, said switch is provided on said upper lid at a position in corresponding to that of said electric power supply unit; and
an ornamental article, said ornamental article is provided in said receiving space between said mirror and said receiving groove of said bottom plate.

2. The lightening ornament with a mirror as claimed in claim 1, wherein an opening is provided on one edge of said receiving groove.

3. The lightening ornament with a mirror as claimed in claim 1, wherein said mirror is formed by electrically plating metallic element of chromium, nickel or aluminum onto a transparent plate.

4. The lightening ornament with a mirror as claimed in claim 3, wherein said transparent plate is made of polyvinyl chloride (PVC), polycarbonate (PC) or pure polymethacrylate.

5. The lightening ornament with a mirror as claimed in claim 3, wherein said electrically plating is done on one side or both sides of said transparent plate.

6. The lightening ornament with a mirror as claimed in claim 1, wherein a pattern, letters, a pattern with a plurality of letters, numerals or symbols are provided on a surface of said ornamental article.

7. The lightening ornament with a mirror as claimed in claim 1, wherein said ornamental article is made of paper, plastic, transparent material or metal.

8. The lightening ornament with a mirror as claimed in claim 1, wherein said electric power supply unit includes at least a storage battery and at least a battery seat.

9. The lightening ornament with a mirror as claimed in claim 8, wherein said storage battery is a lithium battery, normal battery or rechargeable battery.

10. The lightening ornament with a mirror as claimed in claim 1, wherein said storage batteries are connected by an electric power line to municipal electric power.

11. The lightening ornament with a mirror as claimed in claim 1, wherein said lightening unit is a light emitting diode (LED).

12. The lightening ornament with a mirror as claimed in claim 1, wherein said upper lid or said bottom plate is provided with a connecting member to be hung on a key ring or a connecting line on a mobile phone.

13. The lightening ornament with a mirror as claimed in claim 1, wherein said receiving groove has therein a photo or a picture to form a photo frame or a picture frame.

14. The lightening ornament with a mirror as claimed in claim 1, wherein said receiving groove is loaded therein with a liquid crystal display to form a liquid crystal timer.
